(19) United States
(12) Patent Application Publication
(10) Pub. No.: US 2010/0155420 A1
(43) Pub. Date: Jun. 24, 2010

(54) Dispensing System for Cleaning Devices

(75) Inventors: James M. Glenn, Denver, CO (US); Kathy Lockridge, Littleton, CO (US); Paul R. Barnhill, Aurora, CO (US); Jeff Heng, Thornton, CO (US)

Correspondence Address: SHERIDAN ROSS PC, 1560 BROADWAY, SUITE 1200, DENVER, CO, 80202, US

(73) Assignee: RESURGENT HEALTH & MEDICAL,LLC, Golden, CO (US)

(21) Appl. No.: 12/643,786

(22) Filed: Dec. 21, 2009

Related U.S. Application Data
(60) Provisional application No. 61/139,296, filed on Dec. 19, 2008.
(60) Provisional application No. 61/143,395, filed on Jan. 8, 2009.

(51) Int. Cl. B67D 7/84

(52) U.S. Cl. 222/88; 222/1

(57) ABSTRACT

The present invention is directed to a dispensing system for an automated cleaning device. The dispensing system may be operable to deliver a cleaning agent to an automated cleaning station to clean at least a portion of an appendage of a user. The dispensing system includes a receiver component and a bottle that are adapted to be interconnected to the automated cleaning station. The receiver is adapted to accommodate a specific bottle in order to ensure and verify that the proper cleaning agent is being used with the cleaning device.

### CROSS REFERENCE TO RELATED APPLICATIONS

The present application claims the benefit of U.S. Provisional Application Nos. 61/139,296 and 61/143,395 filed Dec. 19, 2008 and Jan. 8, 2009, respectively and entitled “Soap Dispensing System for Automated Cleaning Devices,” each of which is incorporated herein in its entirety.

The present application also cross-references U.S. application Ser. No. 11/617,024 (Attorney Docket No. 5545-3) filed Dec. 28, 2006, entitled “Sanitizer Dispensers With Compliance Verification,” U.S. application Ser. No. 11/689,582 (Attorney Docket No. 5545-7) filed Mar. 22, 2007, entitled “Automated Appendage Cleaning Apparatus With Brush,” U.S. application Ser. No. 11/852,099 (Attorney Docket No. 5545-8) filed Sep. 7, 2007, entitled “Automated Washing System with Compliance Verification and Automated Compliance Monitoring Reporting,” U.S. application Ser. No. 11/617,177 (Attorney Docket No. 5545-1) filed Dec. 28, 2006, entitled “Automated Washing System With Compliance Verification, U.S. application Ser. No. 12/328,712 (Attorney Docket No. 5545-1-DIV) filed Dec. 4, 2008, entitled “Automated Washing System With Compliance Verification,” U.S. application Ser. No. 11/829,769 (Attorney Docket No. 5545-6-1) filed Jul. 27, 2007, entitled “Wash Chamber for Automated Appendage-Washing Apparatus,” U.S. application Ser. No. 12/330,111 (Attorney Docket No. 5545-6-1-DIV) filed Dec. 8, 2008, entitled “Wash Chamber for Automated Appendage-Washing Apparatus,” U.S. application Ser. No. 11/829,783 (Attorney Docket No. 5545-6-4) filed Jul. 27, 2007, entitled “Wash Chamber for Automated Appendage-Washing Apparatus,” U.S. patent Ser. No. 12/331,038 (Attorney Docket No. 5545-6-DIV) filed Dec. 9, 2008, entitled “Wash Chamber for Automated Appendage-Washing Apparatus,” U.S. patent Ser. No. 12/331,118 (Attorney Docket No. 5545-6-DIV-2) filed Dec. 9, 2008, entitled “Wash Chamber for Automated Appendage-Washing Apparatus,” U.S. patent Ser. No. 12/331,175 (Attorney Docket No. 5545-6-DIV-3) filed Dec. 9, 2008, entitled “Wash Chamber for Automated Appendage-Washing Apparatus,” U.S. patent Ser. No. 12/330,111 (Attorney Docket No. 5545-6-1-DIV) filed Dec. 8, 2008, entitled “Wash Chamber for Automated Appendage-Washing Apparatus,” U.S. patent Ser. No. 12/330,145 (Attorney Docket No. 5545-6-2-DIV) filed Dec. 8, 2008, entitled “Wash Chamber for Automated Appendage-Washing Apparatus,” U.S. patent Ser. No. 12/346,198 (Attorney Docket No. 5545-6-3-DIV) filed Dec. 30, 2008, entitled “Wash Chamber for Appendage-Washing Apparatus,” U.S. patent Ser. No. 12/330,179 (Attorney Docket No. 5545-6-4-DIV) filed Dec. 8, 2008, entitled “Wash Chamber for Automated Appendage-Washing Apparatus,” U.S. patent Ser. No. 12/432,693 (Attorney Docket No. 5545-5) filed Apr. 29, 2009, entitled “Complete Hand Care,” U.S. patent Ser. No. 12/432,698 (Attorney Docket No. 5545-11) filed Apr. 29, 2009, entitled “Ingress/Egress System for Hygiene Compliance,” U.S. patent Ser. No. 12/432,718 (Attorney Docket No. 5545-21) Apr. 29, 2009, entitled “Wash Chamber for Surgical Environment,” U.S. patent Ser. No. 12/432,711 (Attorney Docket No. 5545-22) filed Apr. 29, 2009, entitled “Hygiene Compliance,” U.S. patent Ser. No. 12/432,716 (Attorney Docket No. 5545-29) filed Apr. 29, 2009, entitled “Hygiene Compliance Monitoring,” U.S. Pat. No. 5,823,447, U.S. Pat. No. 5,265,628, U.S. Pat. No. 4,817,651, U.S. Pat. No. 4,925,495, U.S. Pat. No. 7,617,830, U.S. Pat. No. 7,607,442, and U.S. Pat. No. 7,607,443, the entire contents of all of these references are incorporated by reference herein in their entirety.

### FIELD OF THE INVENTION

The present invention relates to a dispensing system for use with cleaning devices, and more particularly, to automated cleaning devices comprising a dispensing system used to clean at least a portion of an appendage of a user.

### BACKGROUND OF THE INVENTION

The following text should not be construed as an admission of knowledge in the prior art. Furthermore, citation or identification of any document in this application is not an admission that such document is available as prior art to the present invention, or that any reference forms a part of the common general knowledge in the art.

The importance of cleanliness has long been recognized, particularly in the fields of heath-care, food preparation, and laboratories, to name but a few. The practice of surgical scrubbing by surgeons and other operating room personnel is probably the epitome of efforts to cleanse the hands and forearms of persons working in sterile environments. Although manual hand-washing can appear effective, medical experts have concluded that automated hand-washing increases hand-washing compliance and reduces the risk of infection.

Touchless automated hand-cleaning devices are designed to wash the hands of the user and provide the proper amount of a cleaning agent, such as, a soap, a detergent, a sanitizer, a disinfectant, an antimicrobial solution, a surgical scrub solution, a skin moisturizer/medication, a cosmetic, or a drug, in a set time. These systems diminish the deterrent effects of friction and irritation associated with frequent manual hand-washing. The wash cylinders can be mounted in a free standing device and are adapted to receive the person's hand and forearm. After using an automated hand-cleaning device, a user will typically dry his or her hands. The user may dry his or her hands using a drying device that is interconnected to the automated hand cleaning device. Alternatively, in drying his or her hands, a user may use a disposable towel and/or a separate hand drying device.

The prior art dispensing systems that are used in conjunction with automated hand-cleaning devices have number of disadvantages. Conventional dispensers are separate from the automated hand washing station. This is undesirable because the user is required to remove his or her hands from the washing station in order to apply a cleaning agent to the hands. Additionally, numerous people touch the same dispenser; therefore, the likelihood of contamination increases and the likelihood of maintaining a sterile environment decreases.

To reduce the aforementioned problems, dispensers have been integrated into the automated, non-automated, and partially automated hand cleaning devices. Integrated dispensers help reduce the likelihood of contamination because the user is able to keep his or her hands inside the wash chambers as a cleaning agent is applied directly to the hands. However, the configuration of these integrated dispensers is still unfavorable because a dispenser of any size may typically be used with the automated cleaning device. This is undesirable because it is difficult to verify that the correct cleaning agent is being used. For example, in the hospital environment, it is burdensome to verify that a Food and Drug Administration (“FDA”) approved surgical scrub is being used with the automated cleaning device when any sized bottle may be used with the dispensing system and/or cleaning device.

Moreover, existing cleaning devices lack the ability to incorporate a dispensing system that ensures the proper cleaning agent is used in connection with the automated cleaning device. Thus, there is a long felt need in the field of cleaning devices to provide a cleaning device that includes an improved dispensing system. Accordingly, it would be desirable to provide a dispensing system designed to accommodate certain bottle configurations to ensure and verify that the proper cleaning agent is being used in conjunction with the cleaning device. The following disclosure describes an improved dispensing system which is adapted for interconnection to a cleaning device and which is configured to accommodate specific bottles. Nothing herein is to be construed as an admission that the present invention is not entitled to antedate a patent, publication or invention by another by virtue of prior invention.

### SUMMARY OF THE INVENTION

The Summary of the Invention is neither intended nor should it be construed as being representative of the full extent and scope of the present invention. It is to be understood that the present invention includes a variety of different versions or embodiments, and this Summary is not meant to be limiting or all-inclusive. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

Embodiments of the present invention are directed to a dispensing system for use in connection with an automated, non-automated, or partially automated cleaning device. In one embodiment of the present invention, the integrated dispensing system includes a molded receiver that is adapted to receive a specific bottle. It is an aspect of the present invention that the base of the molded receiver be recessed and include a puncture assembly. More specifically, in one aspect of the present invention, a puncture top is adapted to puncture the seal of the bottle, and a puncture bottom is adapted to interconnect with tubing or other connecting means. It is a further aspect of the present invention that the molded receiver be capable of being mounted in close proximity to the cleaning device.

It is another aspect of the present invention that the bottle have a specific shape and size, including but limited to, a square gallon container or a circular quart container, to be filled with a cleaning agent, such as, a soap, a detergent, a sanitizer, a disinfectant, an antimicrobial solution, a surgical scrub solution, a skin moisturizer/medication, a cosmetic, or a drug. In one embodiment of the present invention the neck of the bottle includes a puncturable seal and a removable cap. More specifically, the cap typically includes a hole and a gasket. It is an aspect of the present invention that the bottle and molded receiver are provided in close association with a cleaning device. In one embodiment of the present invention, the dispensing system is interconnected to an automated cleaning device by means of one or more flexible connecting hoses or piping.

The dispensing system in accordance with embodiments of the present invention is adapted to be used at a particular time during a hand or other wash cycle. In an exemplary embodiment, a user places his or her hands into one or more wash chambers. Then, the bottle dispenses a predetermined amount of cleaning agent from the bottle to the wash chamber and onto an appendage of a user. Once the washing cycle is complete, a drying cycle may begin.

The present invention is directed to a dispensing system, and more particularly, a cleaning agent dispensing system for use in connection with an automated washing apparatus, such as a cleaning station or automated hand-washing machine.

In accordance with the embodiments of the present invention, a dispensing system for use in conjunction with a cleaning station is provided. The dispensing system comprises:

a bottle adapted to hold a cleaning agent, the bottle comprising: an opening, wherein the opening is covered by at least one of a puncturable seal and a cap;

a receiver adapted to receive the bottle, wherein the receiver has a shape commensurate with a shape of the bottle, and wherein the receiver has a base portion;

a puncture assembly positioned in the base portion of the receiver and puncturing the at least one puncturable seal and cap, the puncture assembly comprising:
a puncture top having a puncture member operable to puncture the at least one of the puncturable seal and the cap, wherein the puncture member comprises, a first channel to convey the cleaning agent and a second channel to convey air;

a first hose interconnecting the first channel to the cleaning station, wherein the first hose is adapted to deliver the cleaning agent from the bottle to the cleaning station; and

a second hose interconnected to the second channel, adapted to deliver air to the soap bottle.

In accordance with one or more embodiments of the present invention, a method of dispensing a cleaning agent is provided. The method comprises the steps:
selecting a bottle containing a cleaning agent;
inverting the bottle and positioning the bottle within a receiver;
puncturing the seal by engaging the bottle with a puncture assembly positioned in a base of the receiver, wherein the puncture assembly comprises a first channel for the cleaning agent and a second channel for air;
inserting at least a portion of a user into at least one wash chamber of a cleaning station; and
controlling the flow of the cleaning agent through the first channel to the wash chamber, whereby the cleaning agent is delivered to the at least a portion of the user positioned within the at least one wash chamber of the cleaning station.

In accordance with still further embodiments of the present invention, a dispensing system is provided. The dispensing system comprises:

a receiver adapted to selectively receive a container comprising a cleaning agent, wherein the receiver has a recessed base portion;

a puncture assembly selectively positioned in the recessed base portion of the receiver, the puncture assembly comprising:
a puncture top having a puncture member operable to puncture at least a portion of the container, wherein the puncture member comprises a downwardly extending first and second channels, wherein the first channel is adapted to convey the cleaning agent, and wherein the second channel is adapted to convey air; and
a puncture bottom positioned below the puncture top, wherein the puncture bottom comprises an air tube in fluid communication with the second channel and a cleaning agent tube in fluid communication with the first channel and an air source;

whereby the cleaning agent tube delivers the cleaning agent to at least a portion of a user.

The phrases, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional advantages of the present invention will become readily apparent from the following discussion, particularly when taken together with the accompanying drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a cleaning device in accordance with embodiments of the present invention;

FIG. 2 is a perspective view of the dispensing system of one embodiment of the present invention, showing the receiver and the bottle;

FIG. 3 is another perspective view of the dispensing system of one embodiment of the present invention;

FIG. 4 is a perspective view of the dispensing system of FIGS. 2 and 3, with the bottle removed to show the receiver;

FIG. 5 is a top plan view of the receiver of FIG. 4;

FIG. 6 is a perspective view of the mounting frame of FIG. 2;

FIG. 7 is a perspective view of a bottle of one embodiment of the present invention, shown in a square gallon configuration;

FIG. 8 is a side elevation view of FIG. 7, showing the bottle in a neck-down configuration;

FIG. 9 is a perspective view of a bottle cap in accordance with embodiments of the present invention;

FIG. 10A is a perspective view of the puncture top of one embodiment of the present invention;

FIG. 10B is a perspective view of the underside of FIG. 10A;

FIG. 10C is a cross-sectional view of FIG. 10B;

FIG. 11A is a perspective view of the puncture bottom of one embodiment of the present invention;

FIG. 11B is a perspective view of the underside of FIG. 11A;

FIG. 12A is a perspective view of the puncture gasket of one embodiment of the present invention;

FIG. 12B is an exploded perspective view of the puncture assembly of one embodiment of the present invention;

FIGS. 13A and 13B are additional perspective views of FIG. 2;

FIG. 14 is a perspective view of another embodiment of the present invention, showing a circular quart sized bottle interconnected to the upper cover of a cleaning station; and

FIG. 15 is a perspective view of the receiver of FIG. 14.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

Embodiments of the present invention are directed to one or more elements of a dispensing system for providing a cleaning agent to an appendage or other portion of a person using a cleaning device. A dispensing system in accordance with embodiments of the present invention may be provided in association with a hygiene station that includes other functions, such as drying and compliance verification. It addition, it is to be understood that embodiments of the present invention are also applicable to other types of cleaning, washing and drying systems, including for example, boot-washing systems, general skin cleansing systems, wound wash systems, food service hygiene wash systems, and surgical scrub systems.

The embodiments disclosed herein, or components thereof, are applicable to numerous cleaning agents, as used herein, a “cleaning agent” includes but is not limited to, a soap, a detergent, a sanitizer, a disinfectant, an antimicrobial solution, a surgical scrub solution, a skin moisturizer/medication, an antimicrobial solution, a surgical scrub solution, or other fluid/liquid that may be regulated as a cosmetic, drug, or a combination of both. Cleaning effectiveness can be improved from that of traditional sink and faucet systems, as well as existing automated cleaning devices by using an improved dispensing system.

Various embodiments of the present invention are described in the following text and in the drawings; however, it is to be understood that examples described herein are not meant to be limiting. Accordingly, the scope of the present invention includes modifications and alternatives to the example embodiments described in text and shown in the figures associated herewith.

Cleaning devices, including automated, non-automated, and partially-automated devices, operate to dispense one or more fluids and/or liquids, such as, water and/or a cleaning agent, while a person's hands and forearms are placed in a washbasin. As used herein, a “washbasin” or “wash chamber” means a structure associated with the cleaning station where an appendage or other object (such as a boot or equipment) is cleaned, including for example, one or more wash cylinders, spray areas, pans, tubs, etc. Individuals, such as employees of a laboratory, food service related industry, or health care facility, may be instructed to wash their hands for a predetermined minimum amount of time that is deemed sufficient to provide complete cleaning. In situations where washing and cleansing is required, or because of personal preferences, the user may be required to use (or may otherwise desire to use) a cleaning device that incorporates a dispensing system.

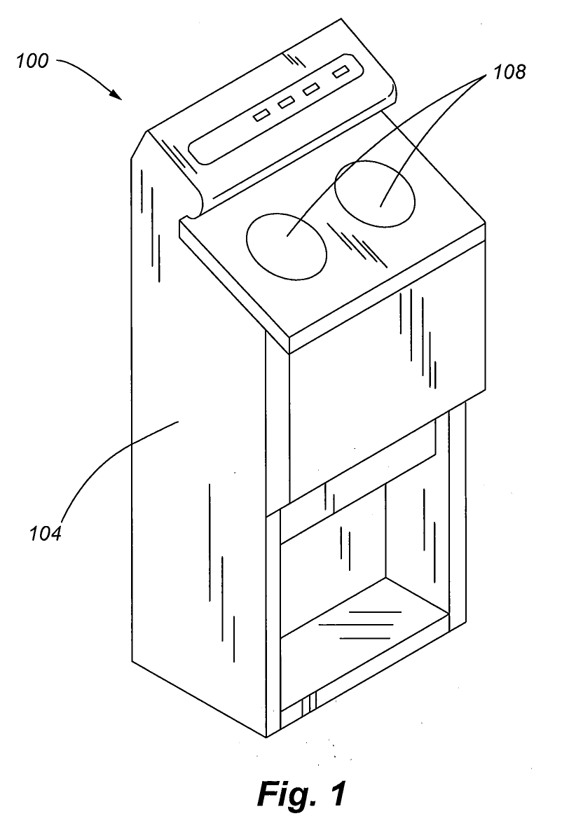

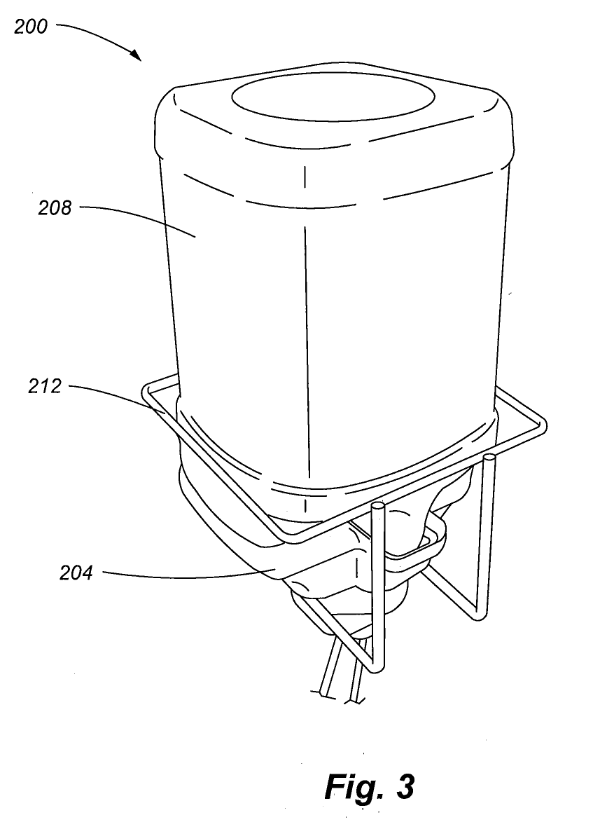

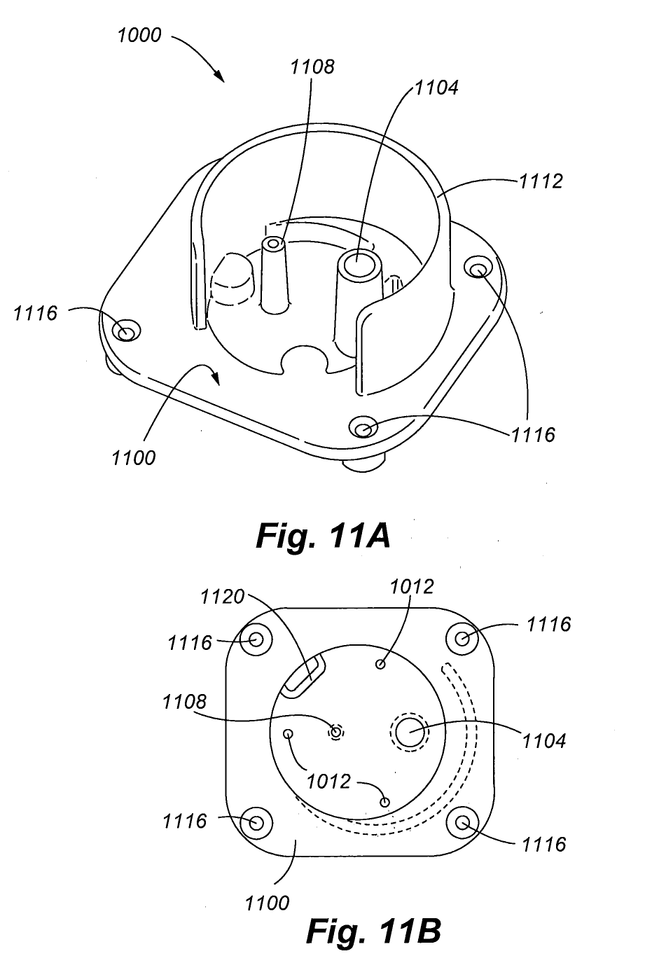

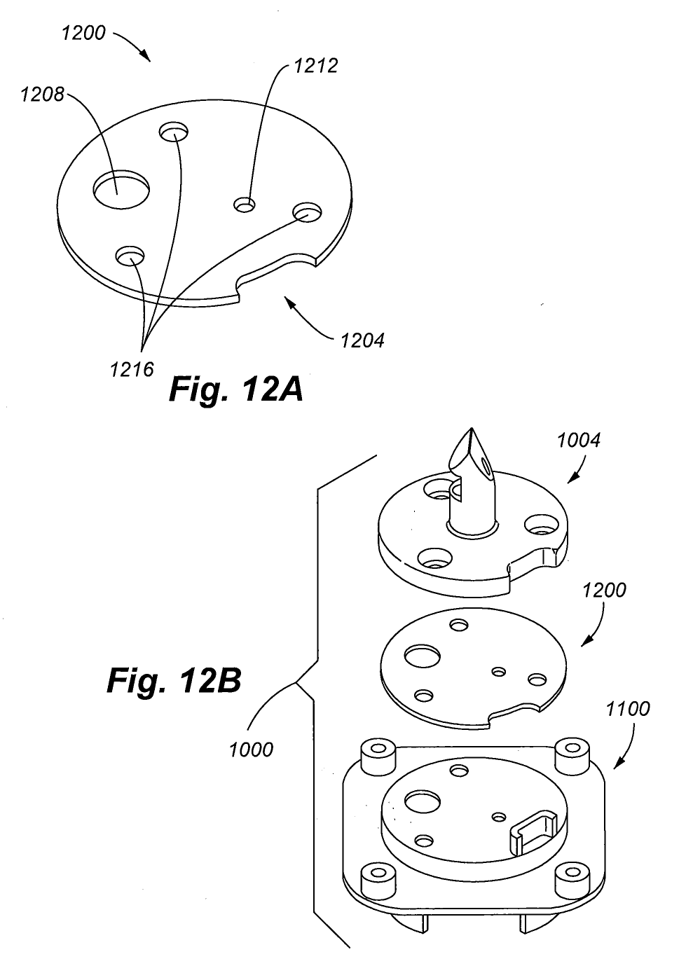

Referring now to FIGS. 1-13, a dispensing system of one embodiment of the present invention is shown. Embodiments of the present invention are used in conjunction with a cleaning station 100. The cleaning station 100 includes a body 104 and a pair of washbasins, and more preferably, wash cylinders 108 residing within the body 104 for receiving an object. As used herein, “object” may refer to anything cleaned by the automated cleaning device. An object may be, for example, an appendage of a user, a tool, a boot, and/or an inanimate object, etc. As used herein, “inanimate object” means an object that is principally not a biological tissue, although biological matter may be associated with the inanimate object, for example, a virus, bacteria, and/or pieces of tissue on equipment. For purposes of discussion, the various embodiments of the present invention are discussed herein in connection to cleaning an appendage of a user. However, it should be understood that the various embodiments of the present invention may be used in connection with other objects.

The cleaning station 100 is shown as a free standing machine. Alternatively, the cleaning station 100 may be incorporated into a counter top, wall, operating room, restaurant, kitchen, or other structure. Embodiments of the present invention include at least one washbasin that comprises a cylinder 108 that rotates around a user's hand and delivers fluids and/or liquids, such as, water and cleaning agents to the user's hands to clean the user's hand. Although referred to and shown as a “cylinder,” the washbasin or wash chamber may comprise another shape. The cylinder may rotate either clockwise or counter-clockwise. Cleaning is accomplished using the dispensing system described herein. As discussed in greater detail below, the dispensing system delivers a cleaning agent, to the cylinders 108 of the cleaning station 100 so that the user's hands may be cleaned during the cleaning station's cleaning cycle.

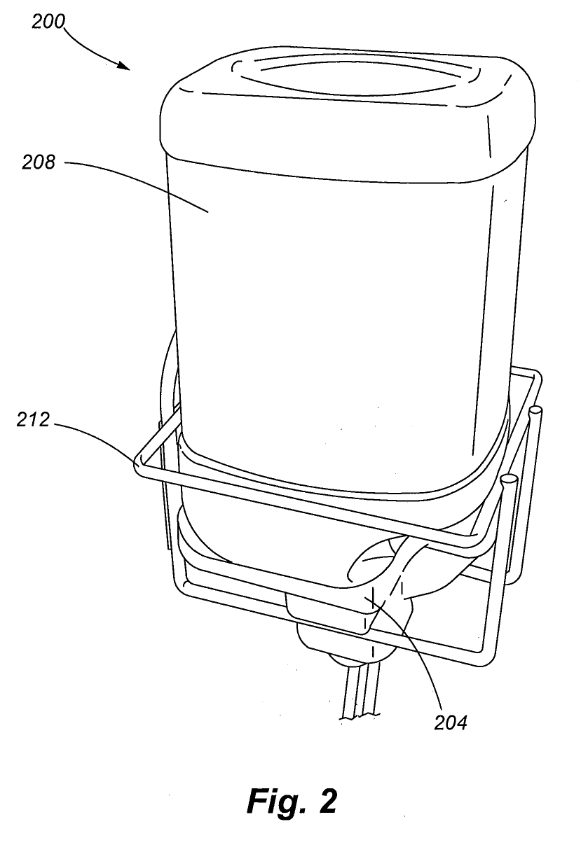

Cleaning may be accomplished by using the dispensing system shown in FIGS. 2-13. The dispensing system 200 is shown as a free standing structure. In one embodiment of the present invention, the dispensing system 200 is mounted in close proximity to a cleaning station 100, such as above, underneath, or adjacent to the cleaning station 100, depending on the space available. Alternatively, the dispensing system 200 may be integrated into an automated cleaning device. The dispensing system 200 includes a receiver 204 and a bottle 208.

The receiver 204 is preferably made of a rigid or semi-rigid material, such as, a metal, thermosetting polymers, or thermoplastics, and is designed to conform to the exterior of the bottle 208. The receiver 204 is adapted to prevent twisting and/or sliding of the received bottle 208. One skilled in the art will also appreciate that the receiver may be made from, partially or exclusively, acrylonitrile butadiene styrene (“ABS”) plastic, polystyrene, polyethylene, polyvinyl chloride, or a softer foam material, such as ethylene-vinyl acetate (“EVA”), that conforms to the shape of the bottle 208. The receiver 204 of one embodiment of the present invention has a shape commensurate with a square gallon container.

The mounting frame 212 may be associated with the dispensing system 200 to mount and receive the dispensing system 200. In one embodiment, the mounting frame 212 is configured as a wall mount to mount the dispensing system 200 to a wall. The mounting frame 212 of one embodiment is positioned in close proximity to the cleaning station 100. One skilled in the art will appreciate that similar mounting mechanisms may be employed to mount the dispensing 200 to another structure or device, such as a surgical scrub device, a restaurant kitchen, or countertop. The mounting frame 212 is preferably made from stainless steel. However, one skilled in the art will also appreciate that the mounting frame 212 may be made from, partially or exclusively, aluminum alloys, other steel alloys, or other sufficiently rigid, strong, and durable material.

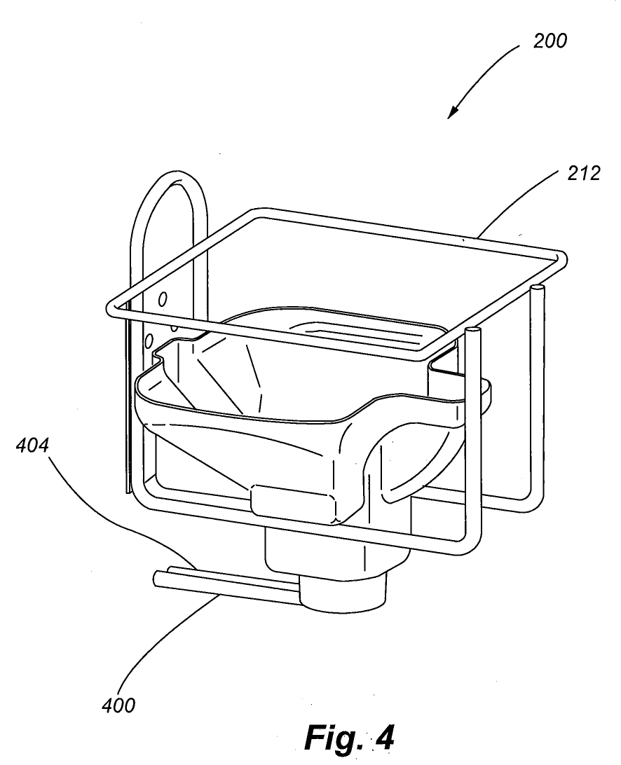

Referring now to FIG. 4, the connecting hoses of one embodiment of the dispensing system 100 are shown. In the embodiment shown, a cleaning agent hose 400 and air hose 404 are interconnected to the puncture assembly (not shown). The cleaning agent hose 400 supplies a cleaning agent to the cleaning station 100. One skilled in the art will appreciate that the length of the cleaning agent hose 400 will depend on how closely the dispensing system 200 is positioned to the cleaning station 100. In one embodiment, the flow of cleaning agent through the cleaning agent hose 400 is automated and controlled by software which electronically opens a solenoid valve (not shown) to allow the cleansing agent to be drawn through another valve (not shown) and ultimately delivered to the cleaning station 100 to wash and clean an object. In one embodiment, an electronic open valve may be set for a predetermined amount of cleaning agent to be dispensed per cleaning cycle. In a preferred embodiment, the cleaning agent dispensing system 200 dispenses 3-5 mL of a cleaning agent through the cleaning agent hose 400 per cleaning cycle. One skilled in the art will appreciate that the amount may vary depending on a customer's specific cleaning agent draw requirements.

The air hose 404 supplies air to the bottle 208 (not shown). As cleaning agent is dispensed from the bottle 208, the air hose 404 allows air to enter the bottle 208 and replace the cleaning agent that is drained out of the bottle 208, thus preventing a vacuum from occurring within the bottle 208 (by equalizing the pressure within the bottle). In one embodiment, the end of the air hose 404 that interfaces with the bottle 208 includes a check valve (not shown) which prevents cleaning agent from getting into the air hose 404. One skilled in the art will appreciate that the connecting hoses may be made of any flexible tube designed to carry fluids and/or liquids and/or gases from one location to another, for example, polyethylene, low density polyethylene, polyvinyl chloride (“PVC”), or synthetic or natural rubbers. One skilled in the art will also appreciate that any number of other connecting hoses may be included in the dispensing system 200 in order to transport fluids and/or liquids and/or gases from the dispensing system 200 to the cleaning station 100.

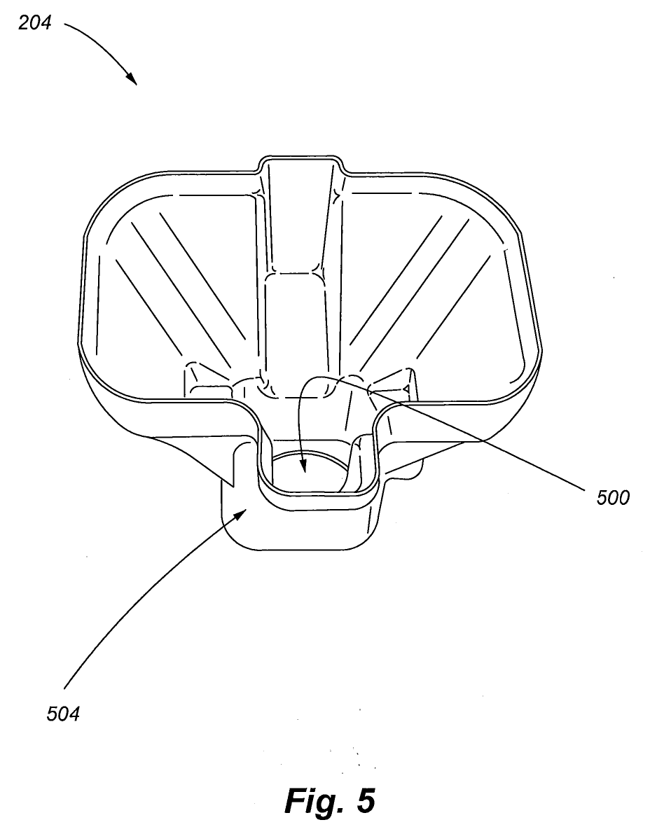

Referring now to FIG. 5, the receiver 204 is shown with the bottle 208 removed. In a preferred embodiment, the receiver is manufactured using blow molding/forming. One skilled in the art will appreciate that other manufacturing techniques, such as injection molding or rotational molding, may be used to form the receiver 204. The receiver 204 is designed to conform to the exterior of the bottle 208. Because the receiver 204 is adapted to receive a specifically sized and shaped bottle 208, the dispensing system 200 ensures that the correct cleansing agent (soap, drug, surgical scrub, moisturizer/medication, antimicrobial or other sterilizing solution, cosmetic, or drug) is used with the cleaning station 100.

The receiver 204 is configured to accommodate the bottle 208 in a neck-down configuration. As such, the base 500 of the receiver 204 is recessed in a downward vertical direction. In one embodiment, the base 500 of the receiver 204 houses the components that puncture the cap of the soap bottle 208 (discussed in greater detail below). In one embodiment, one side of the receiver protrudes outwardly to accommodate the handle of the bottle 208 and the other side is planar so that the dispensing system 200 may be mounted flush with a mounting structure, such as a wall or cleaning station. The outward protrusion 504 enables a user to easily load and remove a bottle 208 from the dispensing system 200.

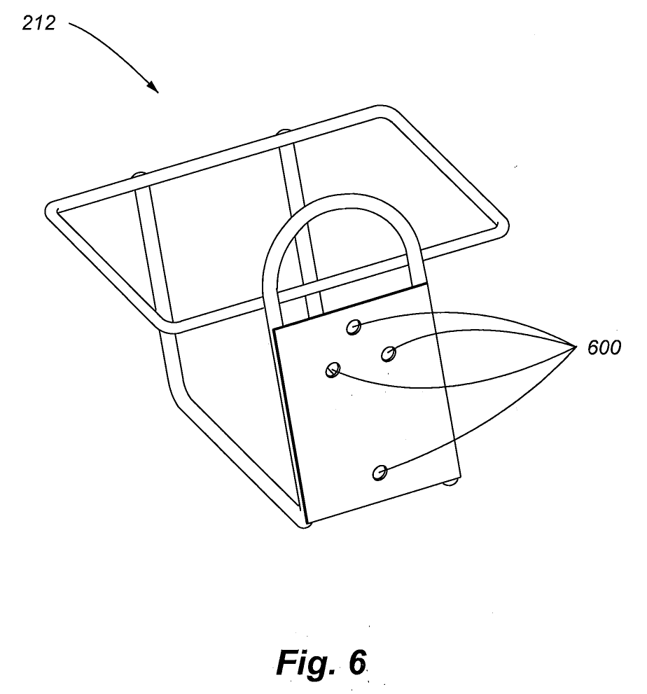

Referring now to FIG. 6, the mounting frame 212 of the dispensing system 200 is shown. The mounting frame 212 houses the components of the dispensing system 200. As such, the mounting frame 212 is designed to accommodate the receiver 204 and bottle 208. In one embodiment, the mounting frame 212 is designed to accommodate a square gallon sized bottle 208. The mounting frame 212 of one embodiment includes screw holes 600 in order to interconnect the dispensing system 200 to an object or structure, such as a wall or cleaning station. In one embodiment, four screw holes 600 are provided on the mounting frame 212. One skilled in the art will appreciate that a number of fastening mechanisms may be use employed, such as bolts, rivets, nails, welding, etc., to interconnect the mounting frame 212 to another object. One skilled in the art will also appreciate that the number and manner of fastening devices may vary depending on the material of the mounting frame 212, the material of the object the mounting frame 212 will be interconnected to, aesthetics, and other design considerations.

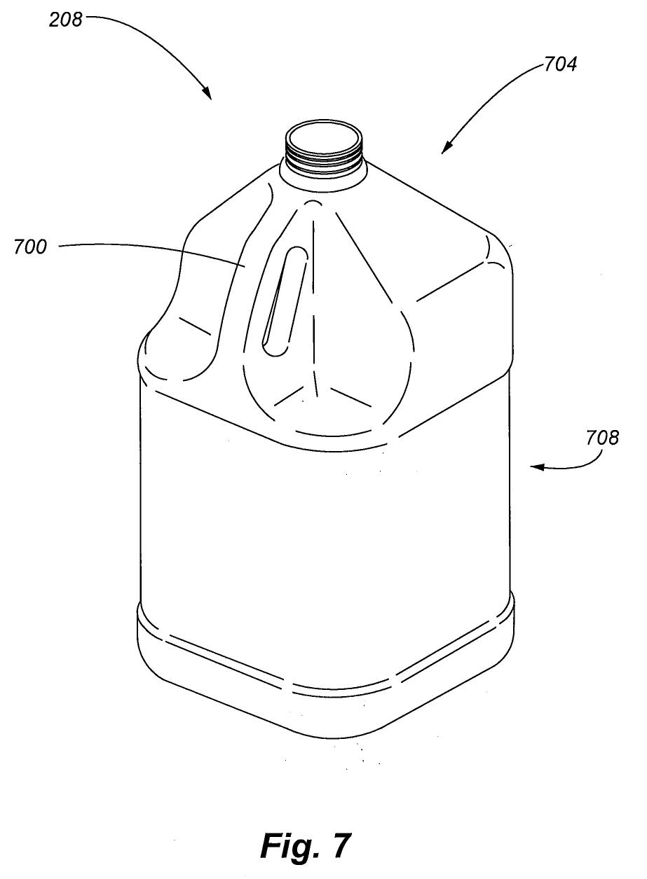

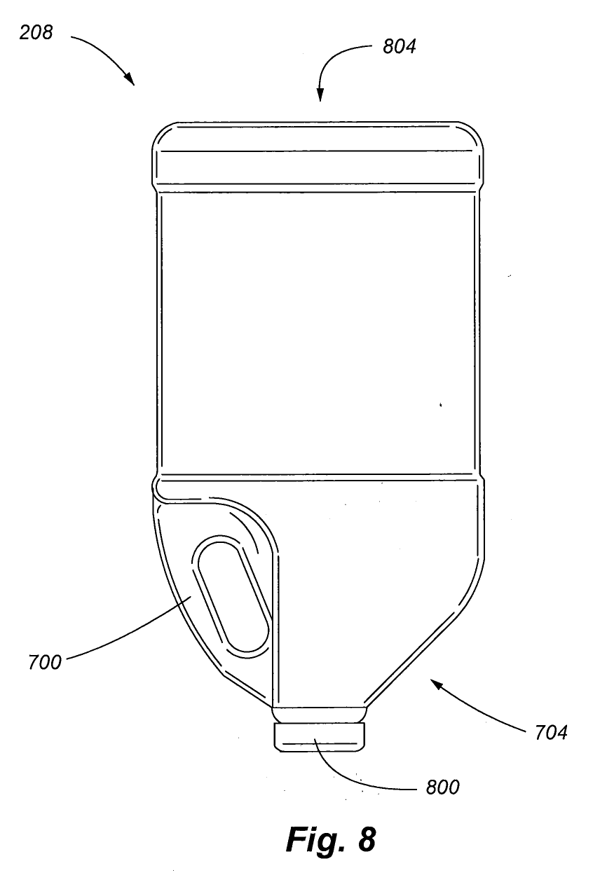

Referring now to FIGS. 7 and 8, the bottle 208 of the dispensing system 200 is shown. In one embodiment, the bottle 208 is designed in a square gallon configuration. The bottle 208 may include a handle 700 for carrying or otherwise transporting the bottle 208. The handle 700 may be especially helpful when the bottle contains a surgical scrub solution or other federally controlled liquid because federal guidelines may dictate that the bottle 208 can not be refilled or reused. As such, when the bottle 208 becomes empty it must be replaced by a new bottle 208. Therefore, the handle 700 enables the user to quickly and easily remove and replace a bottle 208.

The bottle 208 may also include a tapered neck 704 and square body 708. In one embodiment, the neck 704 of the bottle 208 is sized to fit securely within the recessed base 500 of the receiver 204. Preferably, the bottle 208 is made of plastic. In a preferred embodiment the square gallon bottle 208 is federally approved for containing a federally regulated drug, such as a Chlorhexadine Gluconate surgical scrub. One skilled in the art will appreciate that the bottle 208 may be used to store any number of cleaning agents, such as soap, detergent, antimicrobial or other sanitizing solution, surgical scrub solution, moisturizer, cosmetics, drugs and/or other medication.

Referring now to FIGS. 8 and 9, the bottle 208 is shown in a neck-down configuration. In the embodiment shown, the neck 704 of the bottle 208 includes a puncturable seal (not shown) and/or a removable cap 800 which covers the bottle's opening. One skilled in the art will appreciate that the puncturable seal may be made of foil lined thick paper or other puncturable material. The removable cap 800 is preferably capable of twisting on and off the neck 704 of the bottle 208. The removable cap 800 may be made of polypropylene or other thermoplastic polymer or plastic. Alternatively, the cap may include a puncturable seal.

In a preferred embodiment, the removable cap 800 also includes a hole 900 and a gasket (now shown). The hole 900 is sized to accommodate the puncture tube (discussed in detail below). The gasket is sized to fit within the cap 800 to further enhance the compression seal between the neck 704 and the puncture tube (discussed in detail below). The gasket may be made from a variety of gasketing materials, such as rubber, silicone, neoprene, or plastic polymer (i.e., polychlorotrifluroethylene).

The neck 704 of the bottle 208 may also include a shipping cap (not shown) which does not contain a hole. A shipping cap may be positioned on the neck 704 to seal the bottle 208 during shipping (or other transportation), storage, or other times when the bottle 208 is not being used in the dispensing system 200. Thus, in one embodiment of the present invention, the bottle 208 is shipped with a shipping cap (not shown) screwed onto the bottle 208. The removable cap 800 (with the hole 900) and gasket are then shipped with the bottle 208 and shipping cap for later assembly. The bottle 208 may also include an indented portion 804 in the bottom of the soap bottle 208. The size and shape indented portion 804 may vary depending on the material and/or molding technique used to fabricate the bottle 208.

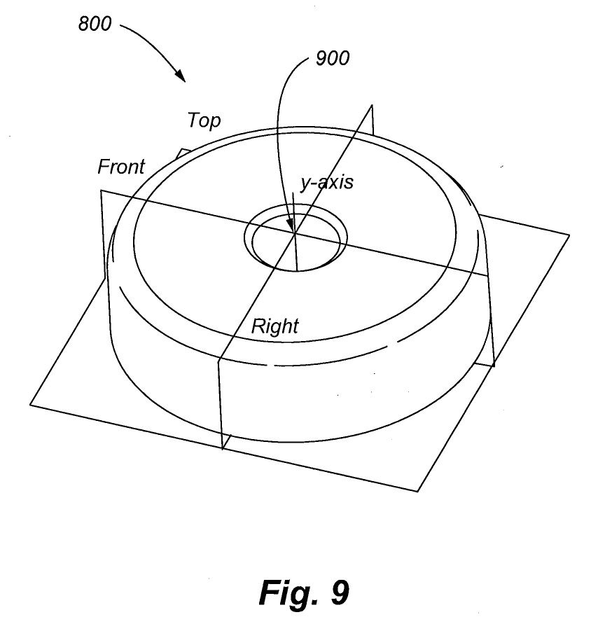

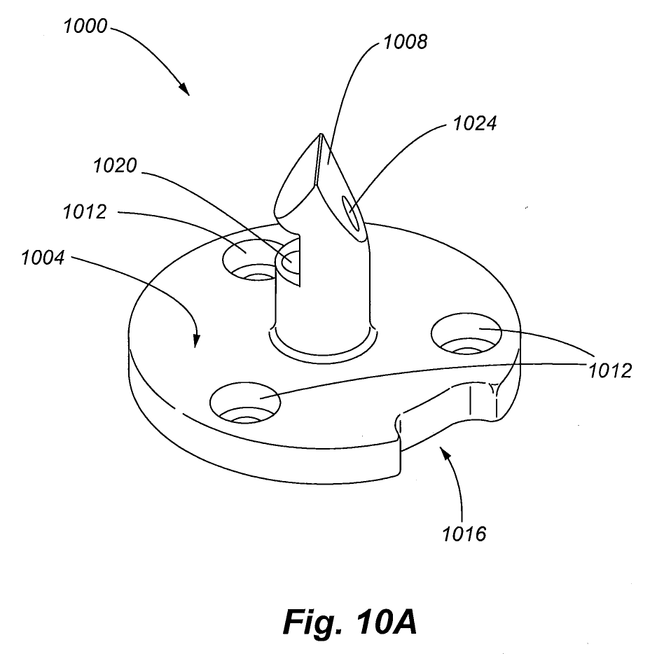

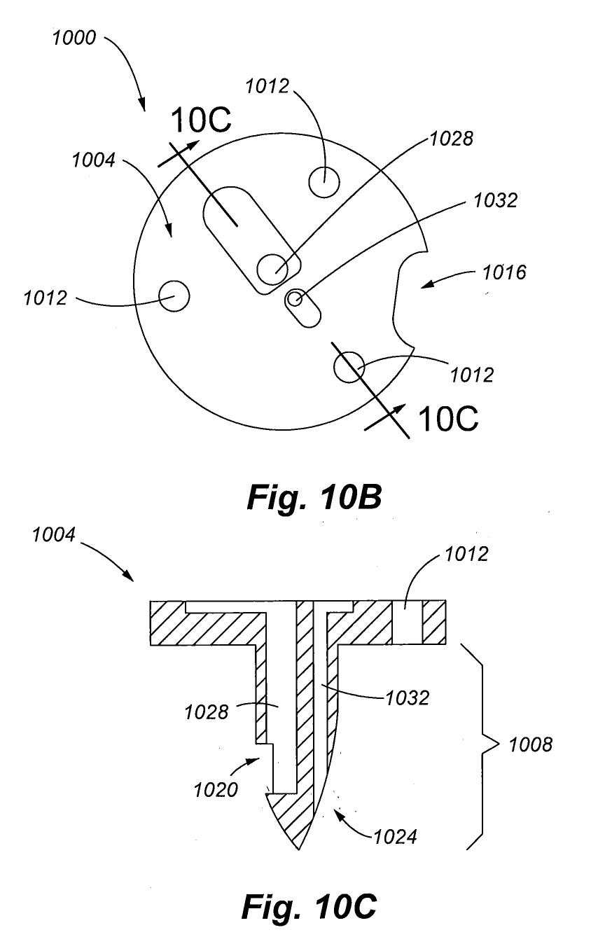

Referring now to FIGS. 10-12, the puncture assembly 1000 of the dispensing system 200 is shown. In one embodiment of the present invention, the puncture assembly 1000 includes a puncture top 1004, a puncture bottom 1100, and a puncture gasket 1200. The puncture assembly 1000 is positioned within the recessed base 500 of the receiver 204. The puncture assembly 1000 is adapted to interconnect to the bottle 208. The puncture top 1004 includes a puncture member 1008. When the bottle 208 is inverted and placed within the receiver 204, a portion of the puncture member 1008 passes through the hole 900 and engages and pierces the puncturable seal of the neck 704 of the bottle 208. One skilled in the art will appreciate that the puncture member 1008 may be made of ABS or other polystyrene moldable plastic, a metal, or any other material that is stronger than the seal. Once the seal is punctured, the cleaning agent may be supplied to the cleaning station 100.

The puncture member 1008 of the puncture top 1004 includes a downwardly extending dual channel having a cleaning agent (input) port 1020 and an air (output) port 1024, each of which are in fluid communication with one of the two channels 1028, 1032. The downwardly extending dual channel thus has one channel for the cleaning agent 1028 and another for air 1032. The cleaning agent port 1020 draws the cleaning agent through the cleaning agent channel 1028 and allows the cleaning agent to exit the bottle 208. Conversely, as air enters the air channel 1032 in response to cleaning agent leaving the bottle 208 through the cleaning agent port 1020, the air port 1024 permits air to enter into the bottle 208. The channel for air 1032 normally has a smaller cross-sectional area normal to the direction of flow than the channel for the cleaning agent 1028. The channel for the cleaning agent 1028 changes direction and continues along the underside of the puncture top 1004 for alignment with a cleaning agent hole (discussed below). The lower portion of the cleaning agent channel may be formed entirely by surfaces of the puncture top 1004 or a combination of surfaces of the puncture top 1004 and a gasket (discussed below). As can be appreciated, the alignment of the dual channel of the puncture member 1008 could be reversed.

The puncture top 1004 also includes mounting screw holes 1012 to selectively fasten the puncture assembly 1000 to the receiver 204. One skilled in the art will appreciate that a number of fastening mechanisms may be use employed, such as screws, bolts, or pins to interconnect the puncture assembly 1000 to the receiver 204. In a preferred embodiment, the puncture top 1004 also includes a positioner 1016 to ensure the cleaning agent and air hoses 400 and 404 are properly aligned. The positioner 1016 ensures that the puncture top 1004 and puncture bottom 1100 fit together in the proper alignment/configuration.

The puncture bottom 1100 is positioned below the puncture top 1004 in a downward facing orientation. The puncture bottom 1100 of one embodiment includes a cleaning agent tube 1104 and an air tube 1108. The cleaning agent tube 1104 interconnects to the cleaning agent hose 400 to transport the cleaning agent from the bottle 208 to the cleaning station 100. The air tube 1108 interconnects to the air hose 404 and allows air to enter the bottle 208 as cleaning agent leaves, in order to equalize the pressure within the bottle 208. The puncture bottom 1100 may also include a protecting wall 1112 that is positioned at least partially circumferentially around the cleaning agent and air tubes, 1104 and 1108, respectively. The protecting wall 1112 protects the tube and hose interconnections from being bumped, disconnected, or broken by other objects, such as a hospital cart or a broom. The protecting wall 1112 also includes a complementary positioning piece 1120 to accommodate and align with the positioner 1016 of the puncture top 1004. To fasten the puncture bottom 1100 to the receiver 204, screw holes 1116 are located on the puncture bottom 1100. One skilled in the art will appreciate that a number of fastening mechanisms may be used to fasten the puncture bottom 1100 to the receiver 204. One skilled in the art will also appreciate that the puncture top 1004 and puncture bottom 1100 may be made of a variety of moldable plastics, such as ABS plastic, polystyrene, or polyethylene.

In a preferred embodiment, the seal between the puncture top 1004 and puncture bottom 1100 is enhanced by means of a puncture gasket 1200. One skilled in the art will appreciate that the puncture gasket 1200 may be made from a variety of gasketing materials, such as rubber, silicone, neoprene, or plastic polymer (i.e., polychlorotrifluroethylene). The puncture gasket 1200 is sized to fit between the puncture top 1004 and bottom 1100. As such, the puncture gasket 1200 has a corresponding positioner 1204 to ensure that the components of the puncture assembly (i.e., puncture top 1004, puncture bottom 1100, and puncture gasket 1200) are properly aligned so that the cleaning agent and air connections do not get misaligned or otherwise offset.

The puncture gasket 1200 also includes a cleaning agent hole 1208 and an air hole 1212. On the upwardly facing side of the puncture gasket 1200, the cleaning agent hole 1208 aligns with a cleaning agent outlet (not shown) to the puncture member's 1008 cleaning agent channel. Likewise, the air channel in the puncture member 1008 has an air inlet (not shown) aligned with the air hole 1212 of the puncture gasket 1200.

In one configuration (not shown), the cleaning agent outlet passes through the cleaning agent hole 1208 and engages (or otherwise connects with) a cleaning agent inlet (not shown) in the cleaning agent tube 1104 in the puncture bottom 1100. Likewise, the air inlet passes through the air hole 1212 and engages (or otherwise connects with) an air outlet (not shown) in the air tube 1108 in the puncture bottom 1100. Alternatively, the cleaning agent inlet and/or air outlet can pass through the cleaning agent and air holes 1208 and 1212, respectively.

In another configuration (not shown), none of the cleaning agent outlet/inlet or air inlet/outlet pass through the cleaning agent and air holes 1208 and 1212, respectively. Rather, each of the cleaning agent outlet and inlet and air inlet and outlet physically contact an opposing side of the gasket 1200 so that the cleaning agent and air do not leak significantly at the interfaces between the outlets and inlets and the gasket.

On the opposite side of the puncture gasket 1200 (the downwardly facing surface), the cleaning agent hole 1208 and air hole 1212 permit the cleaning agent and air tubes, 1104 and 1108, to interconnect with the cleaning agent and air hoses, 400 and 404. When properly aligned, cleaning agent passes through the cleaning agent port 1020 of the puncture member 1008, through the cleaning agent channel, through the cleaning agent hole 1208, through the cleaning agent tube 1104 and cleaning agent hose 400 to deliver the cleaning agent to a cleaning station. In order for air to enter into the bottle 208, the air passes through the air hose 404 and air tube 1108, through the air hole 1212, into the air channel, and through the air port 1024 of the puncture member 1008 and into the bottle 208. Accordingly, the cleaning agent and air flow counter-currently; that is, as cleaning agent leaves the bottle, air flows into the bottle, thereby avoiding a vacuum.

The puncture gasket 1200 may also include screw holes 1216 that align with the screw holes 1012 of the puncture top 1004 to ensure that a tight seal is established between the puncture assembly 1000 and the receiver 204.

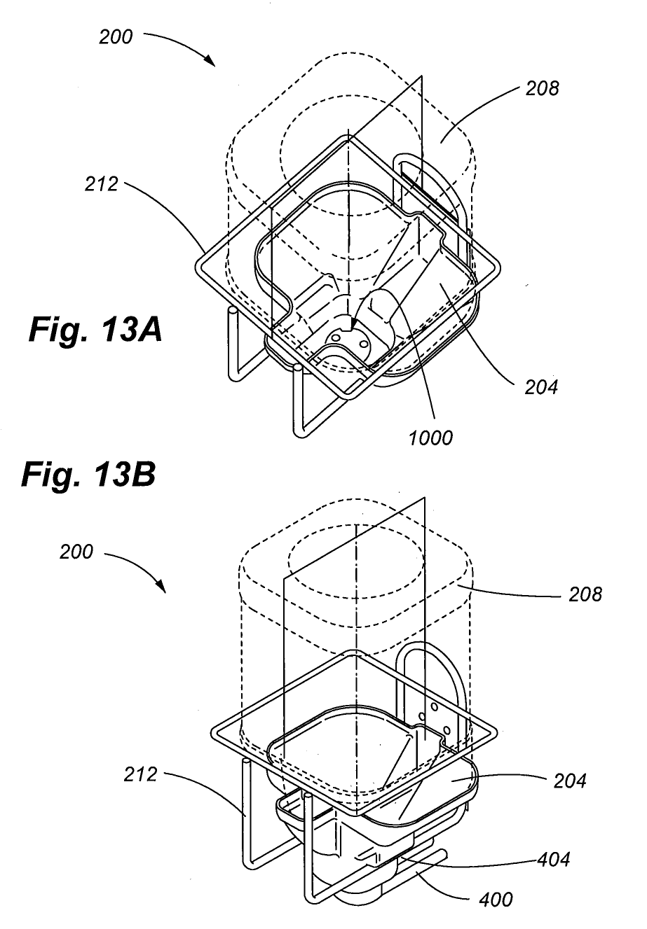

Referring now to FIGS. 13A and 13B, the assembled dispensing system 200 of one embodiment of the present invention is shown. In the embodiment shown, when assembling the dispensing system 200 the user would remove the shipping cap from of the neck 704 of the bottle 208. The user would then ensure that the gasket was placed inside of the cap 800 having a hole 900 and would then screw the cap 800 over the puncturable seal on the neck 704 of the bottle 208. The user would then invert the bottle 208 and position the bottle 208 within the receiver 204. Because of the configuration of the receiver 204, the bottle 208 will only sit flush with the receiver 204 when it is positioned in the correct orientation (i.e., when the handle 700 of the bottle 208 aligns with the outward protrusion 504 of the receiver 204).

When the bottle 208 is placed in the receiver 204, the bottle 208 will engage the puncture assembly 1000 located in the base 500 of the receiver 204. Specifically, the puncture member 1008 of the puncture top 1004 will engage the hole 900 of the cap 800 and puncture the puncturable seal of the bottle 208. Once assembled, the flow of the cleaning agent may be controlled through software which would electronically open a solenoid valve to allow the cleaning agent to be drawn through the puncture member 1008 via the cleaning agent port 1020, and cleaning agent tube 1104 (of the puncture bottom 1100) to another valve that may be pre-set to allow a specific amount of the cleaning agent to flow through the cleaning agent hose 400 to the cleaning station 100 where it will be delivered to an appendage or other portion of a user. As the cleaning agent leaves the bottle 208, air travels through the air hose 404, air tube 1108, through a check valve, and then enters the bottle 208 via the air port 1024 to equalize the pressure in the bottle 208.

Referring now to FIGS. 1, 13A, and 13B, in one embodiment of the present invention, once the dispensing system 200 supplies the cleaning station 100 with a cleaning agent, cleaning may be performed by the application of fluids/liquids to a user's hands, wherein the fluids/liquids may include water, a cleaning agent, such as soap, and/or a disinfectant, such as chlorhexidine gluconate (CHG), and/or other antimicrobial solution, and/or other sterilizing solution, and/or a surgical scrub solution and/or a moisturizer or medication. The fluids/liquids may be directed toward the user's hands through one or a plurality of nozzles, wherein the nozzles provide coverage of cleaning fluids/liquids to the user's hand to clean and rinse the user's hand.

In one embodiment, the user inserts their hand into the cylinders 108 and the cleaning station 100 automatically initiates the dispensing system 200 and associated washing cycle by reading the presence of the user's hand within the cylinder 104, such as by an optical sensor (not shown) or a radio frequency identification (“RFID”) tag. After the completion of the washing cycle, a drying cycle may be initiated that operates to dry the user's hands while his or her hands are within the cylinder 108.

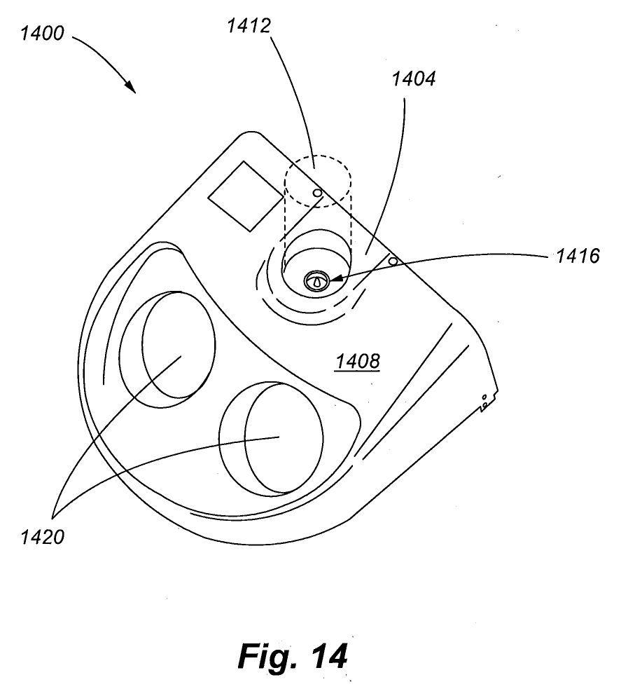

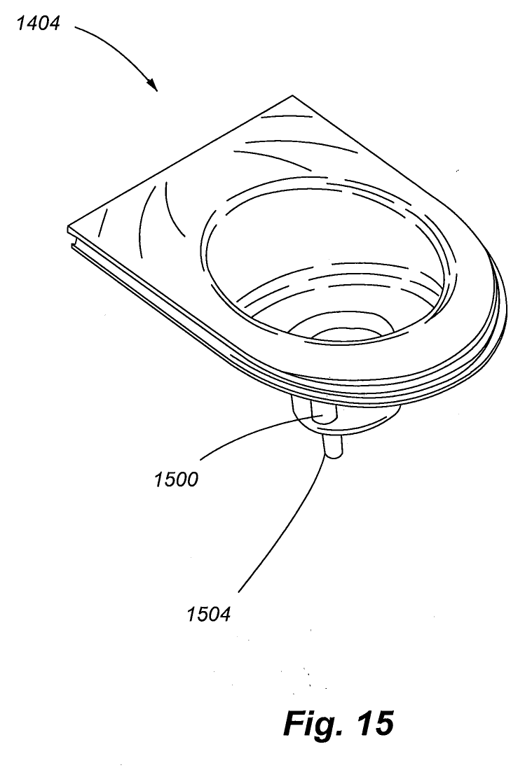

Referring now to FIGS. 14 and 15, another embodiment of the dispensing system is shown. In the embodiment shown, the dispensing system is integrated into an automated cleaning station 1400. The receiver 1404 is integrated into the upper cover 1408 of the integrated soap dispensing cleaning station 1400. In this embodiment, the bottle 1412 has a circular shape and is sized to hold a quart of a cleaning fluid. The receiver 1404 has a shape commiserate with a circular quart sized container. The receiver 1404 is preferably made of a rigid or semi-rigid material, such as a thermally formed plastic and is designed to conform to the exterior of the bottle 1412. The receiver 1404 is adapted to prevent twisting and/or sliding of the received bottle 1412. One skilled in the art will also appreciate that the receiver may be made from, partially or exclusively, ABS plastic, polystyrene, polyethylene, metal, or a softer foam material that conforms to the shape of the bottle 1412. The receiver 1404 may include a mounting point 1500 to further ensure it is fastened and integrated into the upper cover 1408 of the integrated soap dispensing cleaning station 1400.

Similar to the embodiments previously discussed, the bottle 1412 of the integrated soap dispensing system may include a puncturable seal (not shown). When the bottle 1412 is inverted and placed into the receiver 1404, the puncture member 1416 engages the puncturable seal (not shown) and the cleaning agent may travel through a cleaning agent tube 1504 to the wash cylinders 1420 of the cleaning station 1400 and ultimately to an appendage of a user. The integrated dispensing cleaning station 1400 may also include an air tube (not shown) to equalize the pressure in the bottle 1412.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A dispensing system for use in conjunction with a cleaning station, the dispensing system comprising:
a bottle adapted to hold a cleaning agent, the bottle comprising: an opening, wherein the opening is covered by at least one of a puncturable seal and a cap;
a receiver adapted to receive the bottle, wherein the receiver has a shape commensurate with a shape of the bottle, and wherein the receiver has a base portion;
a puncture assembly positioned in the base portion of the receiver and puncturing the at least one puncturable seal and cap, the puncture assembly comprising:
a puncture top having a puncture member operable to puncture the at least one of the puncturable seal and the cap, wherein the puncture member comprises,
a first channel to convey the cleaning agent and a second channel to convey air;
a first hose interconnecting the first channel to the cleaning station, wherein the first hose is adapted to deliver the cleaning agent from the bottle to the cleaning station; and
a second hose interconnected to the second channel, adapted to deliver air to the soap bottle.

2. The dispensing system of claim 1, further comprising:
a puncture bottom positioned below the puncture top, wherein the puncture bottom comprises an air tube in fluid communication with the second channel, a cleaning agent tube in fluid communication with the first channel, and a protecting wall positioned at least partially surrounding the air tube and cleaning agent tube; and
a puncture gasket, adapted to fit between the puncture top and puncture bottom, wherein the puncture gasket has a cleaning agent hole and an air hole in fluid communication, respectively, with the first and second channels.

3. The dispensing system of claim 1, further comprising: a mounting frame adapted to mount and receive the dispensing system, wherein the mounting frame is positioned in close proximity to the cleaning station.

4. The dispensing system of claim 1, wherein cleaning station is configured as at least one of a general hygiene cleaning station, a wound wash system, a food service wash station, and a surgical scrub system.

5. The dispensing system of claim 1, wherein the cleaning agent is at least one of a soap, a detergent, a sanitizer, a disinfectant, an antimicrobial solution, a surgical scrub solution, a cosmetic, and a drug.

6. The dispensing system of claim 1, further comprising at least one electrically operated solenoid valve, wherein operation of the solenoid valve controls the flow of the cleaning agent, and wherein the flow of the cleaning agent is controlled by software.

7. The dispensing system of claim 1, wherein the puncture top further comprises a positioner having a predetermined geometry to align the puncture top and puncture bottom.

8. The dispensing system of claim 1, wherein the bottle further comprises a selectively removable shipping cap adapted to retain the contents of the bottle within the bottle.

9. The dispensing system of claim 1, wherein the bottle is configured as at least one of a square gallon container and a circular quart container.

10. A method of dispensing a cleaning agent, comprising:
selecting a bottle containing a cleaning agent;
inverting the bottle and positioning the bottle within a receiver;
puncturing the seal by engaging the bottle with a puncture assembly positioned in a base of the receiver, wherein the puncture assembly comprises a first channel for the cleaning agent and a second channel for air;
inserting at least a portion of a user into at least one wash chamber of a cleaning station; and
controlling the flow of the cleaning agent through the first channel to the wash chamber, whereby the cleaning agent is delivered to the at least a portion of the user positioned within the at least one wash chamber of the cleaning station.

11. The method of claim 10, further comprising providing a mounting frame, wherein the mounting frame is operable to mount and receive at least one of the bottle and the receiver.

12. The method of claim 11, further comprising positioning the mounting frame in close proximity to the cleaning station.

13. The method of claim 10, further comprising providing at least one of an optical sensor and a radio frequency identification tag.

14. The method of claim 13, further comprising providing compliance verification

15. A dispensing system, comprising:
a receiver adapted to selectively receive a container comprising a cleaning agent, wherein the receiver has a recessed base portion;
a puncture assembly selectively positioned in the recessed base portion of the receiver, the puncture assembly comprising:
a puncture top having a puncture member operable to puncture at least a portion of the container, wherein the puncture member comprises a downwardly extending first and second channels, wherein the first channel is adapted to convey the cleaning agent, and wherein the second channel is adapted to convey air; and
a puncture bottom positioned below the puncture top, wherein the puncture bottom comprises an air tube in fluid communication with the second channel and a cleaning agent tube in fluid communication with the first channel and an air source;
whereby the cleaning agent tube delivers the cleaning agent to at least a portion of a user.

16. The dispensing system of claim 15, further comprising a puncture gasket, adapted to fit between the puncture top and puncture bottom, wherein the puncture gasket has a cleaning agent hole and an air hole.

17. The dispensing system of claim 15, wherein the container is configured as a bottle, and wherein the bottle contains at least one of a soap, a detergent, a sanitizer, a disinfectant, an antimicrobial solution, a surgical scrub solution, a cosmetic, and a drug.

18. The dispensing system of claim 15, wherein the container further comprises an opening, wherein the opening is covered by at least one of a puncturable seal and a cap.

19. The dispensing system of claim 15, further comprising a mounting frame adapted to mount and receive the dispensing system.

20. The dispensing system of claim 15, further comprising at least one of an optical sensor and a radio frequency identification tag, wherein the dispensing system is further operable to provide compliance verification.
